(19) United States
(12) Patent Application Publication
(10) Pub. No.: US 2008/0152500 A1
(43) Pub. Date: Jun. 26, 2008

(54) Inertial particle separator for compressor shroud bleed

(76) Inventor: Carsten Mehring, Aurora, CO (US)

Correspondence Address: STEPHEN GEORGE MICAN, POST OFFICE BOX 1347, WEST POINT, CA, 95255-1347, US

(21) Appl. No.: 11/642,493

(22) Filed: Dec. 20, 2006

(51) Int. Cl. B64C 7/02

(52) U.S. Cl. 416/181

(57) ABSTRACT

An inertial particle separator (IPS) for an inlet bell-mouth that couples an inlet air plenum to a compressor in a gas turbine engine, wherein the IPS removes air particles within reverse air flow passing through at least one bell-mouth aperture in the inlet bell-mouth into shroud bleed apertures in a shroud for the compressor, comprising: at least one baffle that protrudes from each bell-mouth aperture positioned to bend a reverse air flow stream through the bell-mouth aperture to a degree that forces particles out of the reverse air flow stream and into the inlet air plenum.

### FIELD OF THE INVENTION

The invention relates to gas turbine engines, and more particularly to a gas turbine engine that has bleed slots arranged around its compressor shroud.

### BACKGROUND OF THE INVENTION

Gas turbine engines for vehicles, such as helicopters and tanks, that operate in environments with significant particle loading due to atmospheric particulates, such as dust and sand, generally have an inlet design that employs an Inertial Particle Separator (IPS). Commercial aircraft do not generally operate in atmospheric conditions with high particle loading or concentration. Therefore, gas turbine engines for commercial aircraft, such as those employed as an auxiliary power unit (APU), generally do not include an IPS system since damage to the leading edges of their compressor blades due to ingestion of particles such as sand and dust is low.

This is true as long as the compressor ingests airflow through its impeller/inducer inlet plane. In this case, the compressor continuously accelerates the airflow towards the impeller and then directs it through the flow passages in between the rotating blades. Consequently, if particle impact with the blades takes place in this context, impact angles are shallow and/or relative impact velocity is low.

In order to increase operating range, many state-of-the-art gas turbine engines employed as an APU include an aerodynamic control feature referred to as “shroud bleed”. A plurality of shroud-bleed apertures that each penetrate through the outer shroud for the compressor impeller somewhat downstream of the impeller throat allow a certain proportion of compressed air to escape from the compressor shroud and recirculate back through the engine inlet to improve the surge resistance of the compressor under heavy shaft loading conditions. This recirculated air passes through a plurality of bell-mouth apertures that penetrates a bell-mouth that couples the inlet plenum to the compressor. Under certain operating conditions, air flow may enter the compressor stage not only through the compressor inlet plane but also through the shroud-bleed apertures. Such air flow entering through the shroud-bleed apertures into the compressor passages between the impeller blades accelerates from virtually zero velocity to blade-tip velocity. Consequently, the bulk of any particles present within this reverse shroud-bleed air flow shall collide with the rotating impeller blade tips due to their inertia, thereby giving rise to blade erosion or damage.

### SUMMARY OF THE INVENTION

Generally, the invention comprises an IPS for an inlet bell-mouth that couples an inlet air plenum to a compressor in a gas turbine engine, wherein the IPS removes air particles within reverse air flow passing through at least one bell-mouth aperture in the inlet bell-mouth into shroud bleed apertures in a shroud for the compressor, comprising: at least one baffle that protrudes from each bell-mouth aperture positioned to bend a reverse air flow stream through the bell-mouth aperture to a degree that forces particles out of the reverse air flow stream and into the inlet air plenum.

### DESCRIPTION OF THE DRAWINGS

FIG. 1 is a partial cut-away side view of a typical gas turbine engine that has an inlet plenum coupled to a compressor by way of an inlet bell-mouth according to the prior art.

FIG. 2 is an end view of the inlet bell-mouth that couples the inlet plenum to the compressor for the gas turbine engine shown in FIG. 1 according to the prior art.

FIG. 3 is a partial cut-away side view of a gas turbine engine that has an inlet plenum coupled to a compressor by way of an inlet bell-mouth according to a first possible embodiment of the invention.

FIG. 4 is an end view of the inlet bell-mouth that couples the inlet plenum to the compressor for the gas turbine engine shown in FIG. 3 according to a first possible embodiment of the invention.

FIG. 5 is a partial cut-away side view of the inlet bell-mouth that couples the inlet plenum to the compressor for the gas turbine engine shown in FIG. 3 that shows a bell-mouth aperture for the inlet bell-mouth according to a first possible embodiment of the invention.

FIG. 6 is a partial cut-away side view of a gas turbine engine that has an inlet plenum coupled to a compressor by way of an inlet bell-mouth according to a second possible embodiment of the invention.

FIG. 7 is a partial cut-away side view of the inlet bell-mouth that couples the inlet plenum to the compressor for the gas turbine engine shown in FIG. 6 that shows a bell-mouth aperture for the inlet bell-mouth according to a second possible embodiment of the invention.

### DETAILED DESCRIPTION OF THE INVENTION

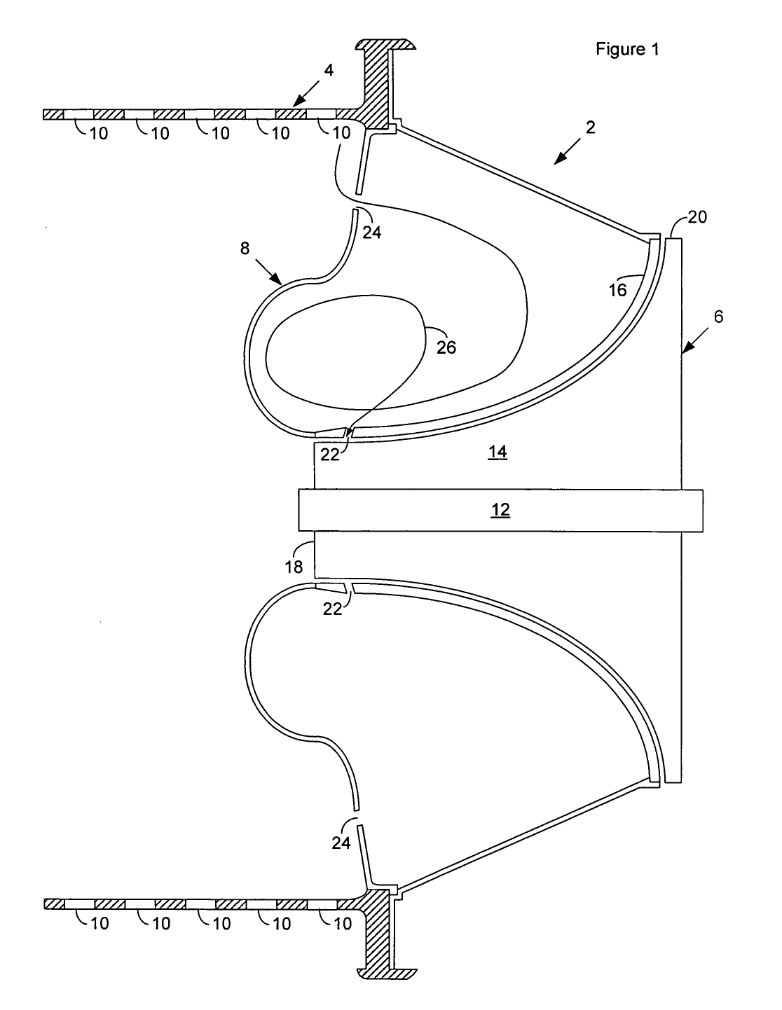

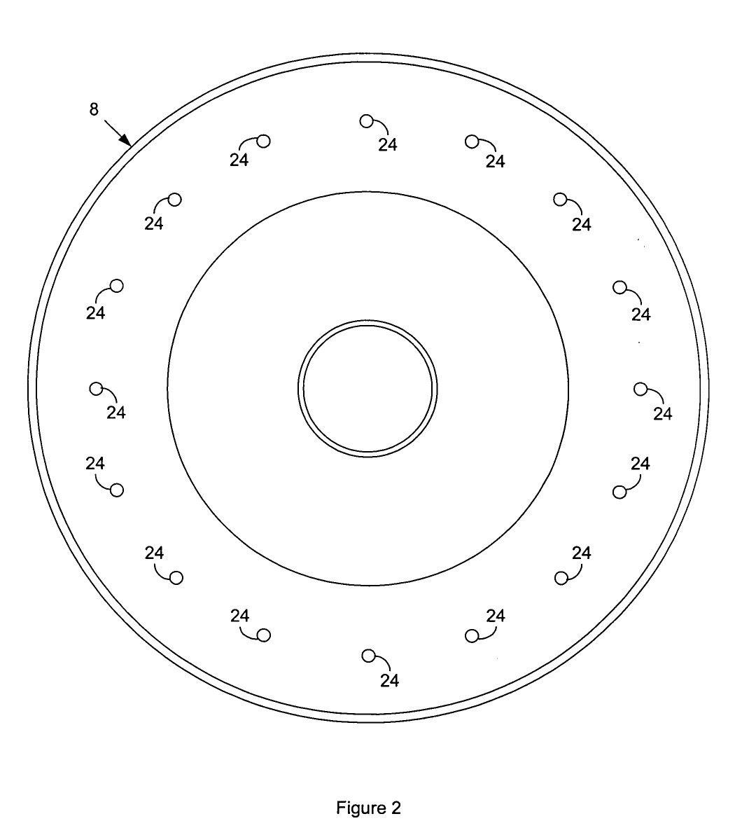

FIG. 1 is a partial cut-away side view of a typical gas turbine engine 2 that has an inlet plenum 4 coupled to a compressor 6 by way of an inlet bell-mouth 8 according to the prior art. FIG. 2 is an end view of the inlet bell-mouth 8 that couples the inlet plenum 4 to the compressor 6 for the gas turbine engine 2 shown in FIG. 1. The inlet plenum 4 allows ambient air to pass through a plurality of inlet air apertures 10. A compressor shaft 12 rotates a compressor impeller 14 within a compressor shroud 16 to suck air within the inlet plenum 4 into a generally axial impeller inlet 18, compress it and discharge compressed air from a generally radial compressor outlet 20.

A plurality of shroud-bleed apertures 22 penetrates through the compressor shroud 16 somewhat downstream of the impeller inlet 18 to allow a certain proportion of compressed air to escape from the compressor shroud 16. This compressed air normally recirculates back through the inlet plenum 4 by way of a plurality of bell-mouth apertures 24 that penetrates the bell-mouth 8. Under certain operating conditions, reverse air flow may flow from the inlet plenum 4 through the bell-mouth apertures 24 and into the shroud-bleed apertures 22. Such air flow entering through the shroud-bleed apertures 22 into compressor passages between blades of the compressor impeller 14 accelerates from virtually zero velocity to blade-tip velocity. Consequently, the bulk of any particles present within this reverse shroud-bleed air flow will collide with rotating impeller blade tips of the compressor impeller 14 due to particle inertia, thereby giving rise to blade erosion or damage of the compressor impeller 14. Line 26 represents a possible path of typical particles that may find their way from the inlet plenum 2 into the shroud bleed apertures 22 in this manner.

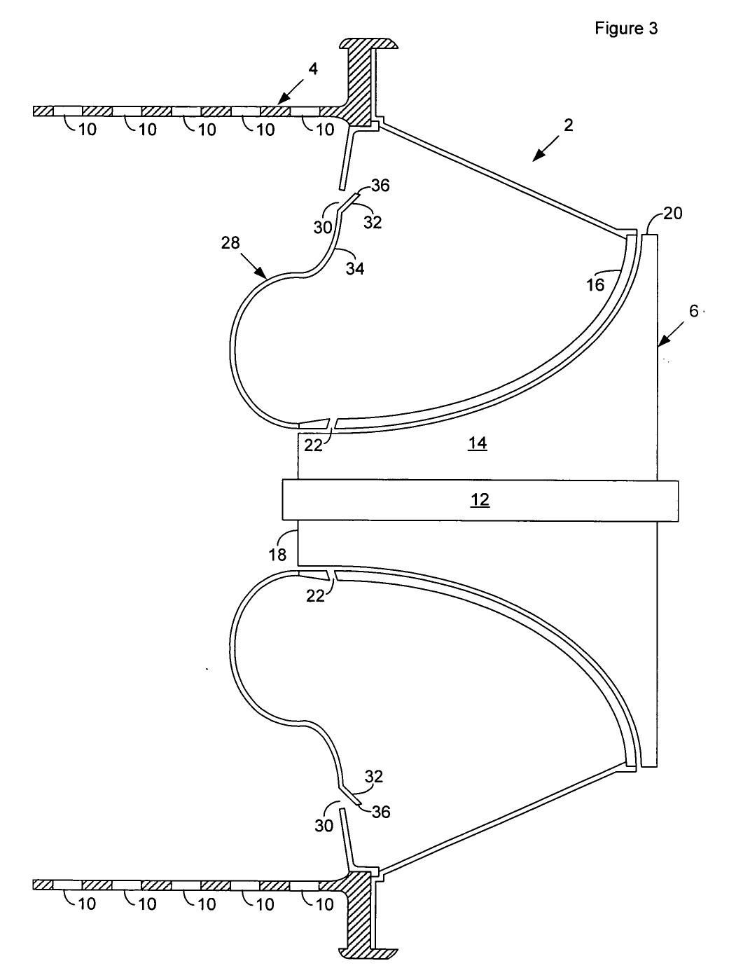

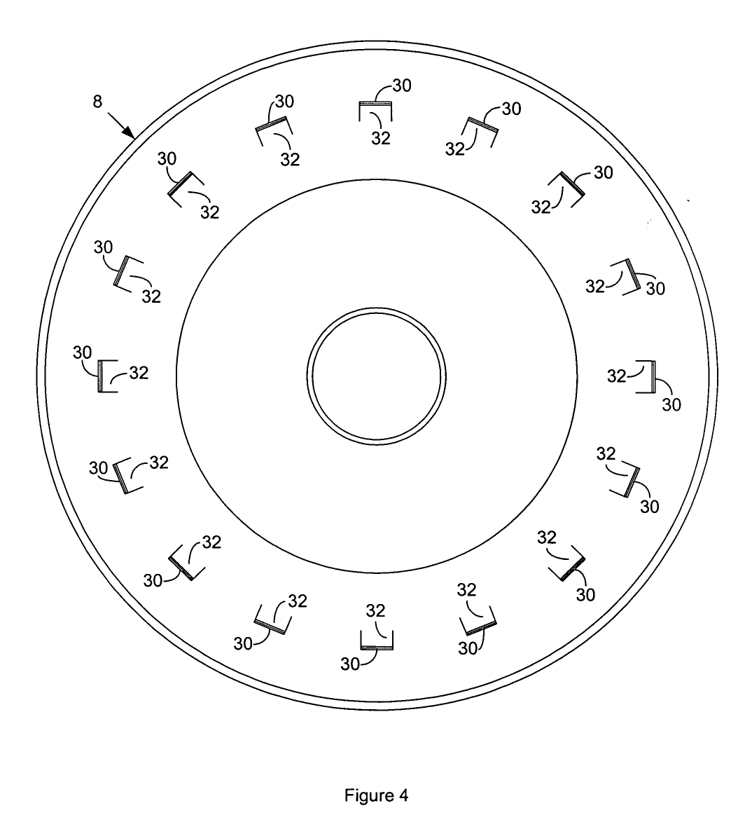

FIG. 3 is a partial cut-away side view of a gas turbine engine 2 that has an inlet plenum 4 coupled to a compressor 6 by way of an inlet bell-mouth 28 according to a first possible embodiment of the invention. FIG. 4 is an end view of the inlet bell-mouth 28 that couples the inlet plenum 4 to the compressor 6 for the gas turbine engine 2 shown in FIG. 3 according to a possible embodiment of the invention. According to this embodiment, the inlet bell-mouth 28 has a plurality of bell-mouth apertures 30. Each bell-mouth aperture 30 has an associated particle-deflecting baffle or louvre 32 along a compressor side 34 of the inlet bell-mouth 28. In one possible embodiment the apertures 30 have a generally rectangular shape. Each baffle 32 extends from the compressor side 34 of the inlet bell-mouth 28 to an outlet end 36.

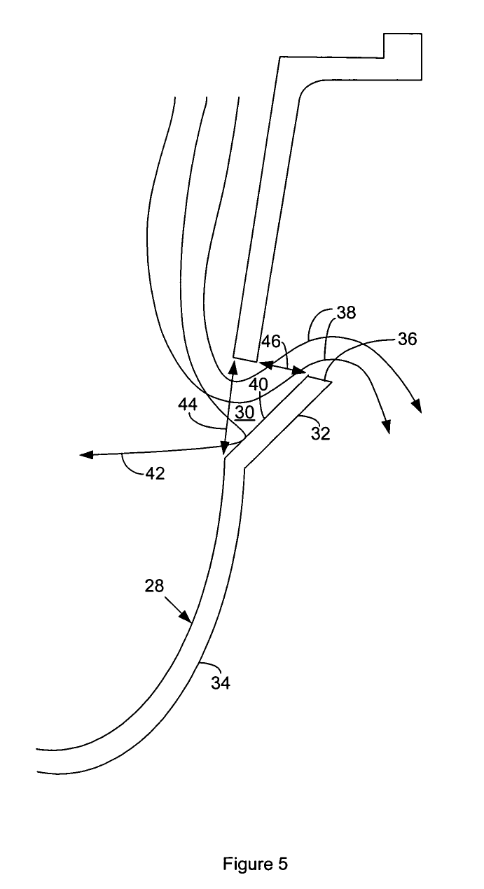

FIG. 5 is a partial cut-away side view of the inlet bell-mouth 28 that couples the inlet plenum 4 to the compressor 6 for the gas turbine engine 2 shown in FIG. 3 that shows one of the bell-mouth apertures 30 with its associated baffle 32 in detail. Lines 38 represent streamlines of reverse air flow through the bell-mouth aperture 30 and associated baffle 32. Curvature of the streamlines 38 increases significantly as the acceleration of the reverse air flow increases from inside the inlet plenum 4 toward the bell-mouth aperture 30. The reverse air flow streamlines 38 penetrate the bell-mouth aperture 30 and bend around an inner surface 40 of the baffle 32 to a degree that any particle with a path that initially follows the reverse air flow, as represented by line 42, can no longer do so due to its inertia. The baffle 32 thereby forces the particle out of the reverse air flow and it deflects off of the baffle 32 back into the inlet plenum 4 downstream of the inlet air apertures 10.

Thus, the baffle 32 bends the reverse air flow to an extent that particles within the reverse airflow remain within the inlet plenum 4. It is possible to optimise the height H of the bell-mouth aperture 30, as represented by line 44, and the length L between the inlet side 34 of the inlet bell-mouth 28 and the outlet end 36 of the baffle 32, as represented by a line 46, to effectively eliminate ingestion of particles in this manner that are larger than a given size.

Although each baffle 32 may have a generally rectangular or wedge-like shape that extends from the compressor side 34 of the inlet bell-mouth 28 to the outlet end 36 of the baffle 32, alternatively each baffle 32 may have different or more complex shapes that perform the same function. For instance, the inner surface 40 of each baffle 32 may be generally curvilinear rather than generally flat as shown in FIG. 5. Each bell-mouth aperture 30 may also have a variety of shapes, such as generally triangular or semicircular, in which case each associated baffle 32 may have a corresponding shape, such as a generally truncated cone or cup-like shape that extends from the compressor side 34 of the inlet bell-mouth 28. Finally, each baffle 32 may comprise a plurality of inner surfaces 40 that deflects particles in the reverse air flow stream back into the inlet plenum 4.

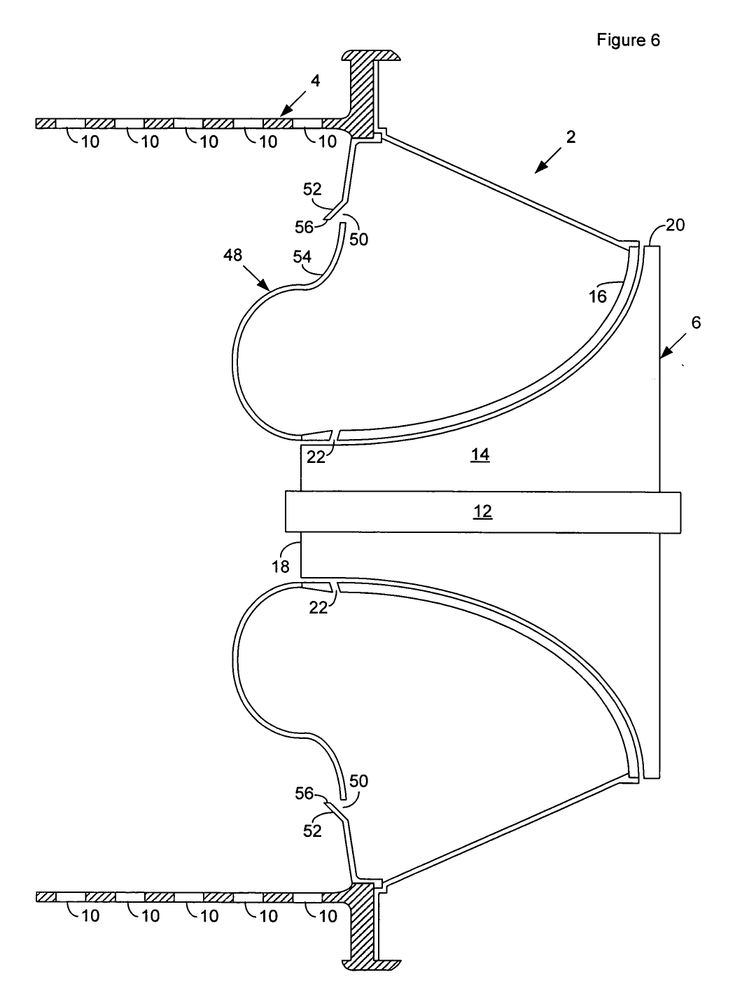

FIG. 6 is a partial cut-away side view of a gas turbine engine 2 that has an inlet plenum 4 coupled to a compressor 6 by way of an inlet bell-mouth 48 according to a second possible embodiment of the invention. It is similar in appearance to the inlet bell-mouth 28 shown in FIG. 3, but it has a plurality of bell-mouth apertures 50. Each bell-mouth aperture 50 has an associated particle-deflecting baffle or louvre 52 along an inlet side 54 of the inlet bell-mouth 48. In one possible embodiment the apertures 50 have a generally rectangular shape. Each baffle 52 extends from the inlet side 54 of the inlet bell-mouth 48 to an inlet end 56.

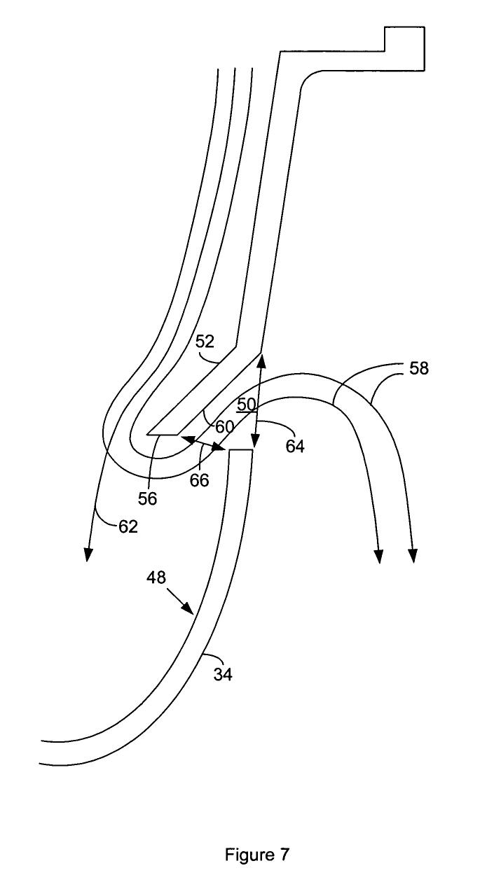

FIG. 7 is a partial cut-away side view of the inlet bell-mouth 48 that couples the inlet plenum to the compressor for the gas turbine engine shown in FIG. 6 that shows one of the bell-mouth apertures 50 with its associated baffle 52 in detail. Lines 58 represent streamlines of reverse air flow through the bell-mouth aperture 50 and associated baffle 52. Curvature of the streamlines 58 increases significantly as the acceleration of the reverse air flow increases from inside the inlet plenum 4 toward the bell-mouth aperture 50. The reverse air flow streamlines 58 penetrate the bell-mouth aperture 50 and bend around an inner surface 60 of the baffle 52 to a degree that any particle with a path that initially follows the reverse air flow, as represented by line 62, can no longer do so due to its inertia. The baffle 52 thereby forces the particle out of the reverse air flow and it then continues its path within the inlet plenum 4.

Thus, the baffle 52 bends the reverse air flow to an extent that particles within the reverse airflow remain within the inlet plenum 4. Again, it is possible to optimise the height H of the bell-mouth aperture 50, as represented by line 64, and the length L between the inlet side 54 of the inlet bell-mouth 48 and the inlet end 56 of the baffle 52, as represented by line 66, to effectively eliminate ingestion of particles in this manner that are larger than a given size.

Once again, although each baffle 52 may have a generally rectangular or wedge-like shape that extends from the inlet side 54 of the inlet bell-mouth 48 to the inlet end 56 of the baffle 52, alternatively each baffle 52 may have different or more complex shapes that perform the same function. For instance, the inner surface 62 of each baffle 52 may be generally curvilinear rather than generally flat as shown in FIG. 7. Each bell-mouth aperture 50 may also have a variety of shapes, such as generally triangular or semicircular, in which case each associated baffle 52 may have a corresponding shape, such as a generally truncated cone or cup-like shape that extends from the inlet side 54 of the inlet bell-mouth 48. Finally, each baffle 52 may comprise a plurality of inner surfaces 62 that separate particles out of the reverse air flow stream so that they remain within the inlet plenum 4.

Any embodiment of the invention, such as the inlet bell-mouth 28 or the inlet bell-mouth 48 hereinbefore described, may comprise a stamping or weldment, such as of sheet metal, or a moulding, such as of plastic or a composite material. The described embodiments of the invention are only illustrative implementations of the invention wherein changes and substitutions of the various parts and arrangement thereof are within the scope of the invention as set forth in the attached claims.

The claimed invention is:

1. For an inlet bell-mouth that couples an inlet air plenum to a compressor in a gas turbine engine, an inertial particle separator (IPS) that removes air particles within reverse air flow passing through at least one bell-mouth aperture in the inlet bell-mouth into shroud bleed apertures in a shroud for the compressor, comprising:
at least one baffle that protrudes from each bell-mouth aperture positioned to bend a reverse air flow stream through the bell-mouth aperture to a degree that forces particles out of the reverse air flow stream and into the inlet air plenum.

2. The IPS of claim 1, wherein each baffle protrudes from an inlet side of the bell-mouth.

3. The IPS of claim 1, wherein each baffle protrudes from a compressor side of the bell-mouth.

4. The IPS of claim 1, wherein each bell-mouth aperture has a height H and each associated baffle has a length L between the compressor side of the inlet bell-mouth and the outlet end of the baffle, with the height H and the length L optimised to force particles out of the reverse air flow stream and into the inlet air plenum that are larger than a given size.

5. The IPS of claim 1, wherein each bell-mouth aperture has a height H and each associated baffle has a length L between an inlet side of the inlet bell-mouth and an inlet end of the baffle, with the height H and the length L optimised to force particles out of the reverse air flow stream and into the inlet air plenum that are larger than a given size.

6. The IPS of claim 1, wherein each bell-mouth aperture is generally rectangular and each associated baffle has a generally wedge-like shape.

7. The IPS of claim 1, wherein each bell-mouth aperture is generally triangular and each associated baffle has a generally truncated cone-like shape.

8. The IPS of claim 1, wherein each bell-mouth aperture is generally semicircular and each associated baffle has a generally cup-like shape.

9. The IPS of claim 1, wherein each inner surface of each baffle is generally flat.

10. The IPS of claim 1, wherein each inner surface of each baffle is generally curvilinear.

11. The IPS of claim 1, wherein each baffle has a plurality of the inner surfaces.

12. The IPS of claim 1, wherein the compressor has an impeller with an axial throat, a radial outlet and the shroud bleed apertures are downstream from the axial throat.

13. An air supply system for a gas turbine engine, comprising:
an air compressor for supplying compressed air to the engine comprising a compressor shroud that has a plurality of shroud bleed apertures;
an inlet air plenum that supplies air for the compressor;
an inlet bell-mouth for coupling the inlet air plenum to the compressor that has a plurality of bell-mouth apertures to allow compressed air that bleeds from the shroud bleed apertures to recirculate through the inlet air plenum back into the compressor; and
an inertial particle separator (IPS) comprising a plurality of baffles that protrude from the inlet bell-mouth, each baffle associated with a corresponding bell-mouth aperture and having at least one inner surface positioned to bend a reverse air flow stream through its corresponding bell-mouth aperture to a degree that forces particles out of the reverse air flow stream and into the inlet air plenum.

14. The air supply system of claim 13, wherein each bell-mouth aperture has a height H and each associated baffle has a length L between a compressor side of the inlet bell-mouth and an outlet end of the baffle, with the height H and the length L optimised to force particles out of the reverse air flow stream and into the inlet air plenum that are larger than a given size.

15. The air supply system of claim 13, wherein each bell-mouth aperture has a height H and each associated baffle has a length L between an inlet side of the inlet bell-mouth and an inlet end of the baffle, with the height H and the length L optimised to force particles out of the reverse air flow stream and into the inlet air plenum that are larger than a given size.

16. The air supply system of claim 13, wherein each bell-mouth aperture is generally rectangular and each associated baffle has a generally wedge-like shape.

17. The air supply system of claim 13, wherein each bell-mouth aperture is generally triangular and each associated baffle has a generally truncated cone-like shape.

18. The air supply system of claim 13, wherein each bell-mouth aperture is generally semicircular and each associated baffle has a generally cup-like shape.

19. The air supply system of claim 13, wherein each inner surface of each baffle is generally flat.

20. The air supply system of claim 13, wherein each inner surface of each baffle is generally curvilinear.

21. The air supply system of claim 13, wherein each baffle has a plurality of the inner surfaces.

22. The air supply system of claim 13, wherein the compressor has an impeller with an axial throat, a radial outlet and the shroud bleed apertures are downstream from the axial throat.

23. A gas turbine engine comprising:
an air compressor for supplying compressed air to the engine comprising a compressor shroud that has a plurality of shroud bleed apertures;
an inlet air plenum that supplies air for the compressor;
an inlet bell-mouth for coupling the inlet air plenum to the compressor that has a plurality of bell-mouth apertures to allow compressed air that bleeds from the shroud bleed apertures to recirculate through the inlet air plenum back into the compressor; and
an inertial particle separator (IPS) comprising a plurality of baffles that protrude from the inlet bell-mouth, each baffle associated with a corresponding bell-mouth aperture and having at least one inner surface positioned to bend a reverse air flow stream to a degree that forces particles out of the reverse air flow stream and into the inlet air plenum.

24. The gas turbine engine of claim 23, wherein each bell-mouth aperture has a height H and each associated baffle has a length L between a compressor side of the inlet bell-mouth and an outlet end of the baffle, with the height H and the length L optimised to force particles out of the reverse air flow stream and into the inlet air plenum that are larger than a given size.

25. The gas turbine engine of claim 23, wherein each bell-mouth aperture has a height H and each associated baffle has a length L between an inlet side of the inlet bell-mouth and an inlet end of the baffle, with the height H and the length L optimized to force particles out of the reverse air flow stream and into the inlet air plenum that are larger than a given size.

26. The gas turbine engine of claim 23, wherein the compressor has an impeller with an axial throat, a radial outlet and the shroud bleed apertures are downstream from the axial throat.
